(19) United States
(12) Patent Application Publication
(10) Pub. No.: US 2004/0113420 A1
(43) Pub. Date: Jun. 17, 2004

(54) Cards with enhanced security features and associated apparatus and methods

(76) Inventors: Wenyu Han, Princeton, NJ (US); Victor Zazzu, Belle Mead, NJ (US)

Correspondence Address: Henry I. Schanzer, Esq., 29 Brookfall Rd., Edison, NJ, 08817, US

(21) Appl. No.: 10/320,239

(22) Filed: Dec. 16, 2002

(51) Int. Cl. B42D 15/00

(52) U.S. Cl. 283/72

(57) ABSTRACT

A card embodying the invention includes a substrate with first and second overlying patterns formed over the substrate. The first and second patterns are random relative to each other and define a resultant pattern which is extremely difficult, if not impossible, to duplicate even by the manufacturer of the card. The resultant pattern may be sensed and signals corresponding to the resultant pattern may be either stored in a storage element on the card or in a data base off the card. When the card is subsequently inserted in a card reader in order to be used by a user, the card reader reads the resultant pattern and compares the reading with the signals stored on the card or in the data base which is off the card to ascertain whether the card is valid.

### BACKGROUND OF THE INVENTION

This invention relates to instruments with enhanced security features and to apparatus and methods associated with the enhanced security of these instruments.

The invention will be illustrated using cards such as commonly used plastic cards. However in the specification to follow and in the appended claims, it should be understood that when reference is made to “cards”, instruments and documents of all types (including money orders such as postal money orders and travelers checks) are meant to be included, although not specifically identified as such.

Many credit or ID cards include highly sophisticated elements (e.g., a hologram) for providing a degree of security to the card holder and to the system in which the card is to be employed. However, these sophisticated elements add substantial costs to the manufacture of the cards and often do not provide the desired level of security. By way of example, it is relatively expensive to manufacture a card containing a hologram. In addition, in order to “read” a card containing a hologram a laser based reader is required and such readers tend to be expensive.

Accordingly, it is an object of the invention to form cards which are difficult, if not impossible, to be counterfeited and at little additional expense.

It is another object of the invention to be able to read these difficult to counterfeit cards with relatively inexpensive readers.

### SUMMARY OF THE INVENTION

A card embodying the invention includes a substrate with first and second different patterns formed over the substrate. The first and second patterns are formed in a manner such that they are random relative to each other. The combination of the first and second patterns define a resultant pattern which is extremely difficult, if not impossible, to duplicate even by the manufacturer of the card. The resultant pattern may be sensed and signals corresponding to the resultant pattern may be stored either in a storage element on the card or in a data base off the card. When the card is subsequently inserted in a card reader in order to be read, the card reader reads the resultant pattern and compares the reading with the signals stored on the card or in the data base which is off the card to ascertain whether the card is valid.

In cards embodying the invention, a first pattern may be formed on a card. Then, a second pattern (which may include a metal strip) is laid down along the length (or the width) of the card so as to cover the whole, or part, of the first pattern. Cut outs, also referred to as “windows”, may be formed along the second pattern. The cut outs function as windows to enable the sensing of the underlying (or overlying) first pattern. The cut outs may be of different size and shape and may be located anywhere along the length or width of the second pattern. A resultant pattern includes a combination of the portions of the first pattern sensed within cut outs of the second pattern.

In one embodiment of the invention, the second pattern includes a metal strip with cut outs and the edges of the cut outs (i.e., “windows”) along the metal strip may also be used to define one pattern and as identification markers to define the start and the stop of an underlying (or overlying) pattern. Thus, the edges of the cut outs define one pattern, the information corresponding to the underlying pattern contained within each cut out defines a second pattern and the combination of the first and second pattern defines a third pattern. Any one, or all, of the three patterns may be read and stored on the card or in a data base located off the card for subsequently determining the validity of the card.

The underlying pattern may be formed by placing optical marks, such as fibers or threads, in a random or programmed manner between two layers of a card. The random placement may include placing the fibers parallel to each, but with the spacing between the fibers being random. The underlying pattern may include a randomly formed bar/space pattern, where the spacing between the bars and the widths of the bars vary in a random manner.

Cards embodying the invention may include an underlying, first, pattern formed of a material which is non-visible to the human eye (e.g., invisible inks), and a second, overlying, pattern which includes a metallized strip overlying the first pattern.

In systems embodying the invention, a resultant pattern may be determined by sensing the pattern existing along a scan line running along the length of the metal strip across the cut outs. Alternatively, a resultant pattern may be determined by sensing the pattern existing along a plurality of scan lines running along the length of the metal strip across selected cut outs. Note that the edges of the cut outs may be generally perpendicular or at an angle to the length (or width) of the card and/or to the underlying pattern. Thus, different scan lines, parallel to each other, along the height of the cut outs may generate different patterns.

In either case the resultant pattern may be determined by a reader/sensor and information corresponding thereto may then be stored either on the card or in a data base located off the card. Subsequently, when the card is inserted in a reader by a person to whom the card is issued, the card is read and the information read from the card is compared to the stored information (located on or off the card) to determine whether the card is valid.

### BRIEF DESCRIPTION OF THE DRAWINGS

In the accompanying drawings like reference characters denote like components; and

FIG. 1 shows a top view of portion of a card which includes two patterns, one overlying the other, randomly formed relative to each other, in accordance with the invention;

FIG. 1A illustrates the laying down of a metal strip on different cards in a non-registered manner;

FIGS. 1B, 1C, 1D, 1E, and 1F show the cross section of different cards embodying the invention;

FIG. 1G is a diagram of waveforms generated by the security pattern of FIG. 1;

FIGS. 1H(a)-(f) shows various views and steps in the manufacture of a card with different optical marks in accordance with the invention;

FIG. 2 shows a layout of a portion of a card embodying the invention including one patterned layer using ink stripes of varying widths over which is placed a metal strip;

FIG. 3 shows a layout of a card embodying the invention in which one layer includes randomly placed fibers;

FIG. 4 is still another layout of a card embodying the invention;

FIG. 5 shows a layout of a card embodying the invention and the use of multiple scan lines to read the security features of the card;

FIG. 6 is a simplified block diagram of apparatus for sensing security information present on cards embodying the invention and then, either encoding the information on the card or transmitting the security information to an off the card data base;

FIG. 7 is a flow chart of steps in the manufacture of cards embodying the invention;

FIG. 7A is a flow chart of steps in the validation of a card embodying the invention; and

FIG. 8 is a simplified block diagram of a reader for use with cards embodying the invention.

### DETAILED DESCRIPTION OF THE INVENTION

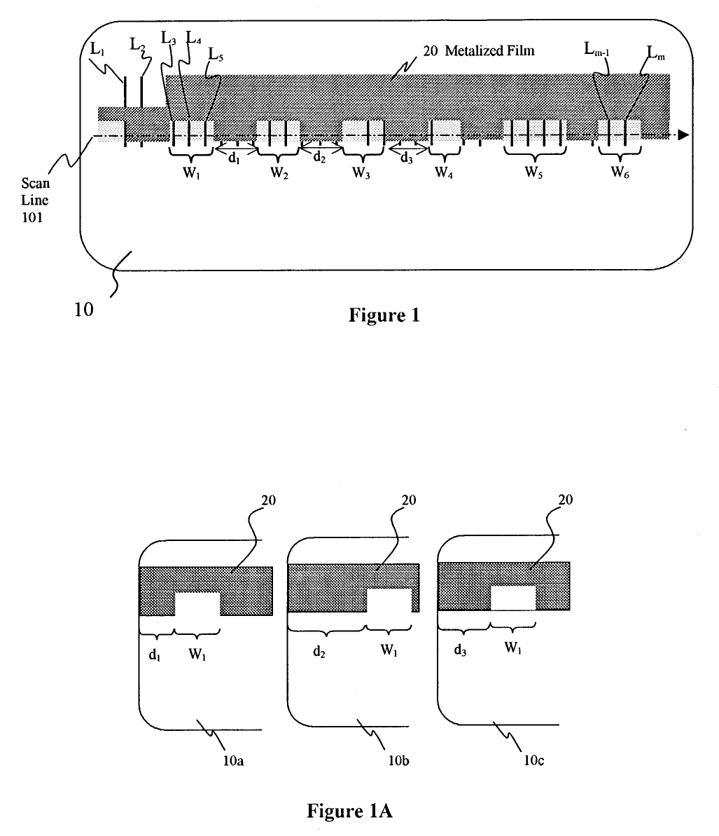

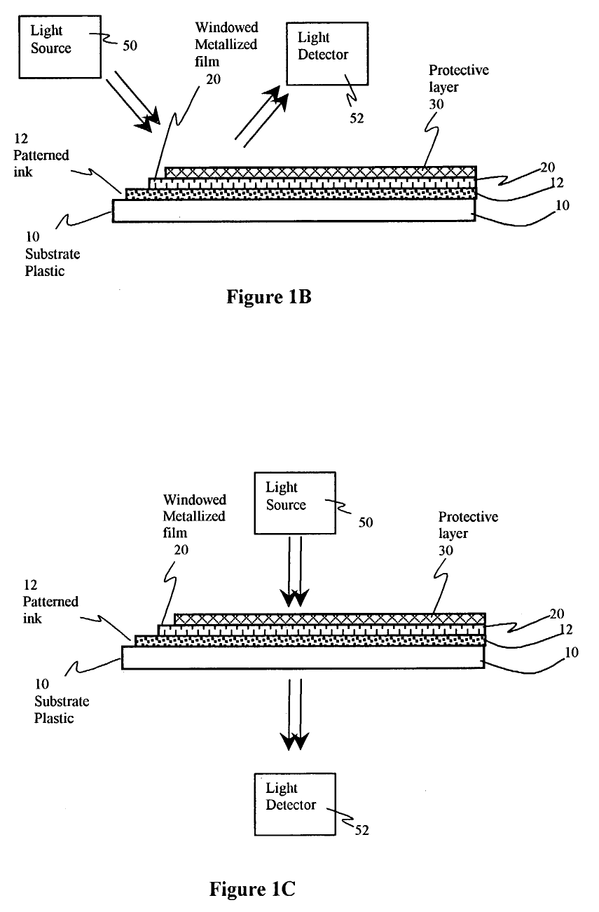

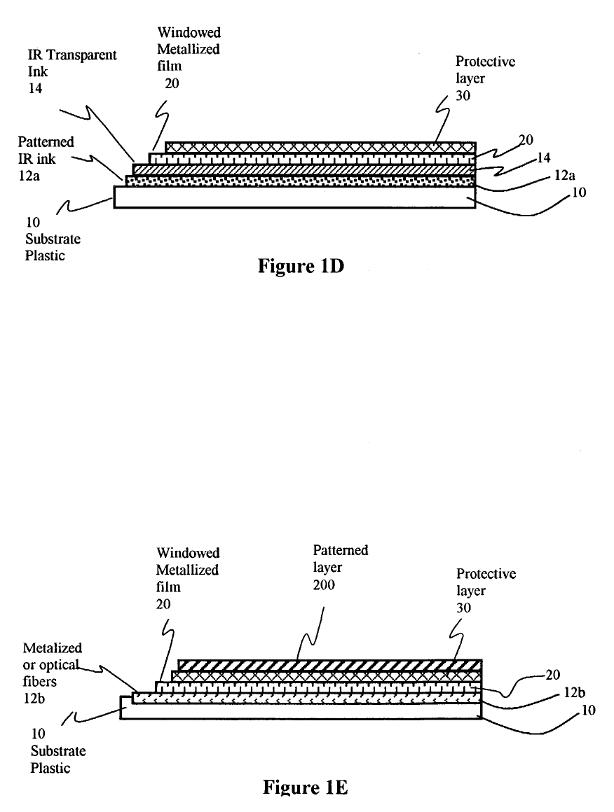

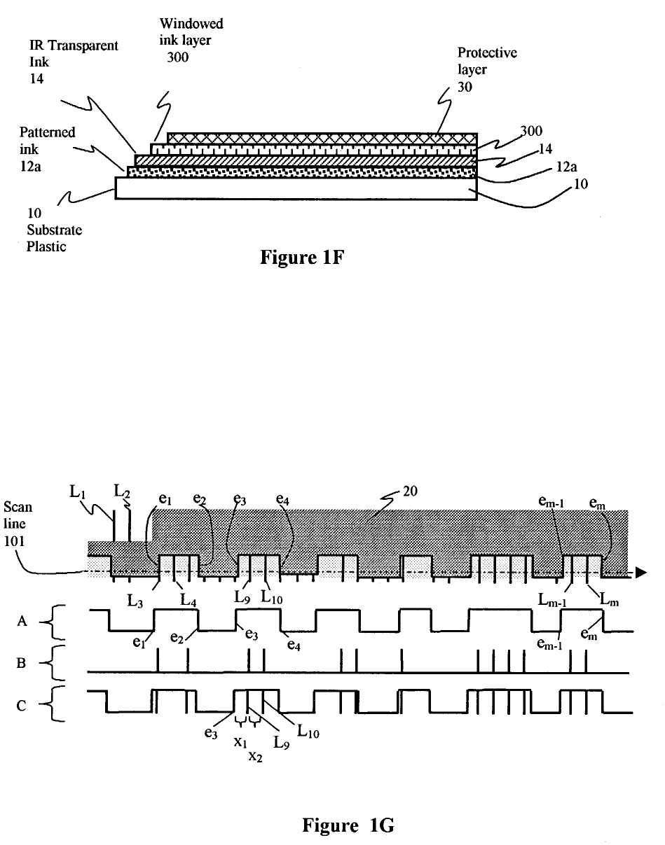

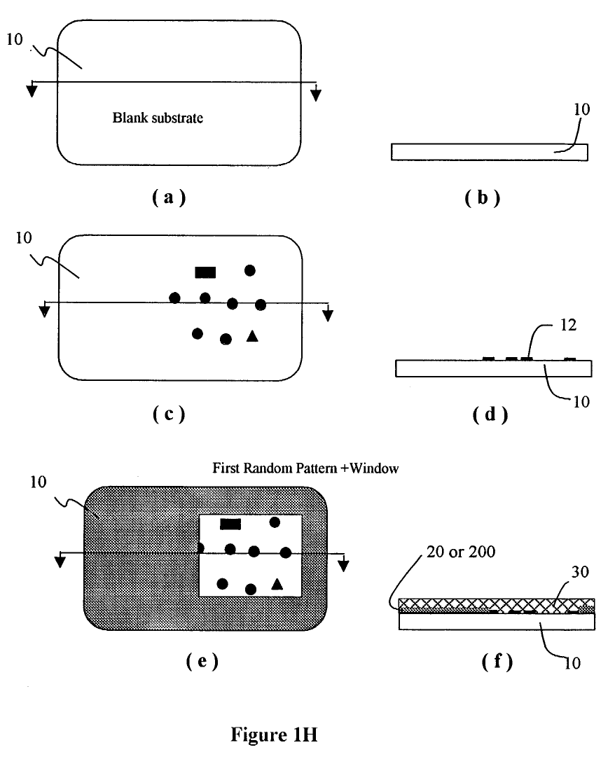

Referring to FIG. 1 there is shown a portion of a card having a substrate 10 along whose length a series of vertical stripes or lines (e.g., L1-Lm) have been formed or placed. In this embodiment, these stripes define a first pattern or layer formed on the card. A metallized film 20 is formed (or placed) over the first layer (e.g., vertical stripes L1-Lm). Portions of the metal film 20 have been removed to provide cut outs or windows (e.g., W1-W6) in order to expose the underlying stripes. The various windows (e.g., W1-W6) may be of different widths and the spacing (e.g., d1, d2, d3) between the windows may also be of different length. Thus, the various windows (e.g., W1-W6) may be of different size and shape relative to each other and the distance (e.g., d1, d2, d3) between the windows may all be different. For example note that, in scanning across the windows of FIG. 1 along scan line 101, three stripes (L3, L4, L5) are seen across window W1, two stripes are seen across window W2, one stripe is visible across W3 or W4, four stripes are visible across W5 and two stripes are visible across W6.

Thus, in accordance with one aspect of the invention, a first patterned layer, which may include a series of lines (L1-Lm), is formed (e.g., printed) on a card substrate. Subsequently, a second layer, which may include a metalized film strip 20 with cut outs (i.e., windows), is placed or formed over the first layer. The stripes or elements (L1-Lm) forming the first layer may be formed so as to define a first pattern which may be either totally random or which may have a predictable programmed pattern. Likewise, the shape and spacing of the windows along each strip 20 may be formed to produce a second pattern which may be either totally random or which may have a predictable programmed pattern. By forming the first and second patterns independently or each other and then combining them in a random manner relative to each other (so that there is no prior relationship as to how they are combined) a unique resultant pattern is generated for each different combination of the first and second patterns. Thus, FIG. 1 shows a metalized film 20 with cut-outs (W1-W6) which may be “randomly” placed over randomly or regularly spaced ink stripes. This forms a security pattern that is extremely difficult to duplicate.

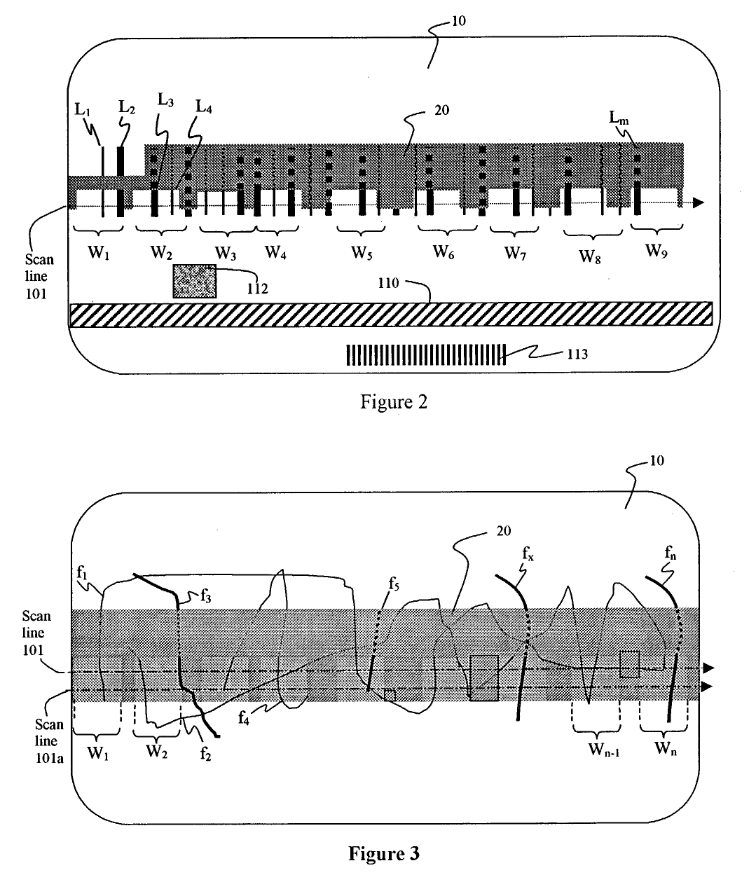

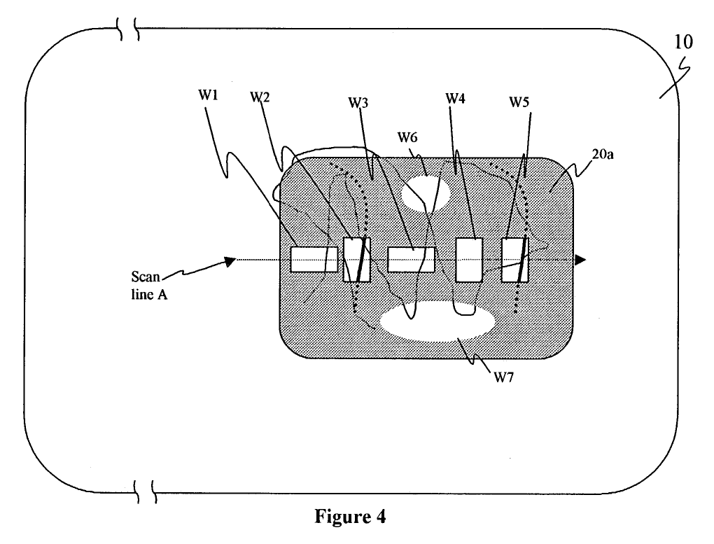

The first pattern may include stripes L1-Lm which may be made using ink lines (as shown in FIGS. 1 and 2). Alternatively, the first pattern may be formed using various optical marks (as shown in FIG. 1H) or optical fibers or threads (as shown in FIGS. 3 and 4). The spacing between the ink lines (e.g., L1-Lm) may be varied and the width of each line may be varied (as shown in FIG. 2). In FIGS. 1, 2 and 5, the lines L1-Lm are shown to be formed parallel to each other; however that need not be the case and their relative orientation may be totally random (as shown in FIGS. 3 and 4). The ink stripes can be made of visible inks and materials or they can be made of inks and materials which are responsive to certain selected optical wavelengths (i.e., UV or IR spectra) that are not in the visible range.

The metalized film strip 20 with the cut outs may be placed on the card in a non-registered manner. That is, the same metallized film strip 20 with its cut outs (e.g., W1) may be positioned on a card 10 with non-repeating indexing (i.e., non-registered) with respect to the edge of the card. Thus, as shown in FIG. 1A, for card 10a, the window W1 begins a distance d1 from the edge of the card, and for cards 10b and 10c, the same window (e.g., W1) begins a distance d2 and d3, respectively, from the edge of the card, where d1, d2 and d3 may have different values. Thus, the film strips 20 may be formed having similar patterns; but, by placing the film strip down on a card in a non-registered manner, even if the ink stripe pattern is non-random, the resultant patterns of the ink stripes and the windows of the film strip will generally be different for different cards. Thus, “n” cards may be formed with n different ink stripe patterns or with the same ink stripe pattern. Then, a different one of “n” metalized film strips, each metal strip having the same or different cut outs, may be placed in a non-registered manner across a corresponding one of the n cards. As a result, an extremely large combination of different patterns may be formed that are extremely difficult to duplicate.

In the discussion above it was assumed that ink stripes are first formed on the card substrate and a metal film strip is then placed over them. It should be understood that the metal strip may be positioned first with a second layer over it or underneath it. Also, in the discussion above, reference is made to a first layer (e.g., a layer of ink stripes) and a second overlying layer comprised of a metal strip with cut outs (e.g., windows). A metal strip is used because it reflects light and provides good contrast. It thus provides an effect similar to a hologram, without requiring the expensive readers needed to read holograms. However, it should be understood that the metal strip may be replaced by a non-metallic strip (which may be another ink layer printed on top of the first patterned layer as shown in FIG. 1F). The non-metallic second layer, like the metallic strip, would either totally block or totally reflect incident light except in those regions of the non-metallic strip where windows have been cut out. Note that FIG. 1F shows a substrate 10, a patterned ink layer 12, an IR transparent ink layer 14, a windowed ink layer 300 (i.e., a non metallic layer with cut outs similar to the cut-out in the metallic film strip) and a protective layer 30.

As already noted, the inks used to form (print or place) the line stripes (L1-Lm) on the cards may be visible or invisible (e.g., they may be responsive to UV or IR light) to the eye or they may have various predetermined wavelengths. To take care of the various cases, appropriate light sources (e.g., 50 shown in FIGS. 1B and C, 6 and 8) capable of generating light having the requisite wave lengths are used to illuminate the card (i.e., stripes and/or windows) and appropriate optical detectors (photodetector or photosensor 52 in the various figures) capable of sensing these wavelengths are used to sense the resultant security patterns. The optical detectors are programmed to read/sense the signals in the windows and to detect the pattern (e.g., IR or UV ink stripes) present within each window. The readers detect the unique pattern formed by the convolution of the pattern due to the “windows” and the underlying first (e.g., ink) pattern. The sensed optical “fingerprint” can then be stored on an information storage device located on the card (e.g., a magnetic stripe 110 or a semiconductor chip 112 or as part of a bar code 113) and/or it can be stored off the card in a data base in a central computer or any arbitrary location.

Combining two (or more) different patterns to generate a large number of different cards having different resultant patterns may be accomplished in several ways as discussed below. Referring to FIGS. 1B and 1C, there is shown a (not to scale) cross section of cards embodying the invention. Each card includes a substrate 10 over which is formed (printed or placed) a first layer 12 which includes a pattern of (randomly formed or regularly patterned) stripes (e.g., L1-Lm). As noted above, the stripes in the first layer may be formed from materials such that the stripes are either visible or invisible (IR or UV inks) to the naked eye. Referring to FIGS. 1, 1B and 1C, overlying the first layer 12 is a second layer 20 which includes a metallized film in which windows (e.g., W1-W6) of different shapes have been formed. The windows (e.g., W1-W6) allow light from a light source 50 to be projected onto the stripes and for the light pattern due to the stripes to be either reflected from the stripes (see FIG. 1B) or to be transmitted through the substrate (see FIG. 1C) to a sensor 52. A protective layer 30 may be formed over layer 20. This layer 30 is typically transparent to the light source 50 used to illuminate the underlying pattern. Each card (instrument) may be characterized as having a top surface (e.g., protection layer 30) and a bottom surface (e.g., substrate 10) with one or more intermediate layers between the top and bottom surfaces.

Referring to FIG. 1D there is shown a (not to scale) cross section of another card embodying the invention. The card includes a substrate 10 over which is formed (printed or placed) a first patterned layer 12a which includes a pattern of (randomly formed or programmably patterned) stripes (e.g., L1-Lm). Overlying the first layer 12a is a layer 14 of an ink which would be transparent to an IR light source but which would block the patterned layer from being seen in response to visible light. A metallized film layer 20 and a protective layer 30 overly layer 14, performing a similar function to that described for those layers in FIGS. 1B and 1C.

Referring to FIG. 1E there is shown a (not to scale) cross section of still another card embodying the invention. The card includes a substrate 10 over which is formed (or placed) a first layer 12b which includes a pattern of (randomly formed or programmed) fibers. The fibers may be optical or metal fibers and they may be formed on top of the substrate or they may be embedded within the top surface of the substrate 10, as illustrated in FIG. 1E. Layers 20 and 30 overly layer 12b performing a similar function to that described for FIGS. 1B-1D. In addition to layer 20, or instead of layer 20, a patterned layer 200 may be formed on top of the protective layer 30 or embedded within the top layer 30. FIG. 1E may represent an instrument in which the substrate 10 and the protective layer 30 represent the bottom and top surfaces, respectively, of an instrument (e.g., a postal money order, a traveler's check or the like). One or more patterns may be formed in the space between the top and bottom surfaces which may include one or more intermediate layers. Then, and additional pattern 200 may be formed within or above the top surface. The patterns may be random or programmed and may include bar code or alpha-numeric information.

FIG. 1F is like FIG. 1D with the windowed or patterned metal layer 20 replaced by a “windowed” or patterned ink layer 300. Thus, in FIG. 1F, the various patterns are formed in different ink layers. In general, the substrate 10 may represent the bottom surface of an instrument (e.g., a postal money order), the protective layer 30 may represent the top surface of the instrument, the space between the top and bottom surface enables one or more patterned layers to be formed between the top and bottom surfaces.

FIG. 1H(a) through (f) illustrates various steps in forming a card using random optical patterns to produce a security pattern. FIGS. 1H(a) and 1H(b) show a top view and a side view, respectively, of a blank substrate 10. FIGS. 1H(c) and 1H(d) show a top view and a side view, respectively, of random optical marks (e.g., circles and rectangles formed as a first layer on the substrate 10. FIGS. 1H(e) and 1H(f) show a top view and a side view, respectively, of a “windowed” pattern (20 or 200) overlying the random optical pattern 12. FIG. 1H(f) shows a protective layer 30 formed over the underlying first and second patterns.

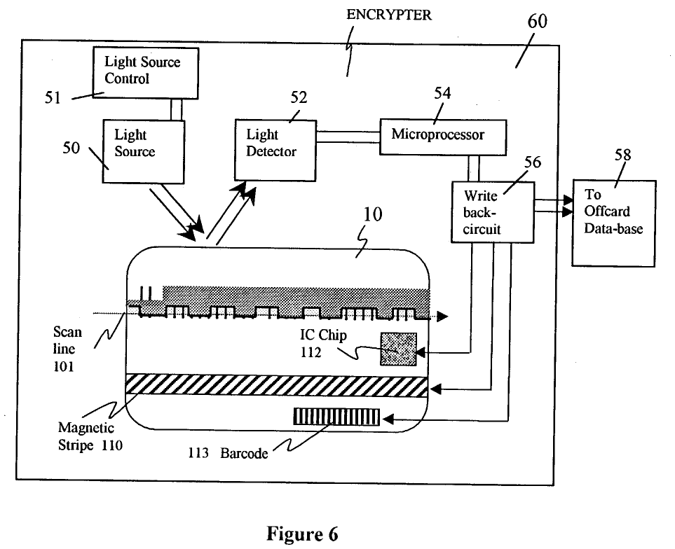

The security pattern for each card may take many different forms as already discussed above. Referring to FIG. 2, there is shown a portion of a card where the ink stripes (L1-Lm) are made of varying widths. By way of example, FIG. 2 shows nine (9) windows (W1-W9); with each window containing thick and/or thin stripes. FIG. 2 shows the use of stripes having two different widths; but it should be understood that the ink stripes could have a multiplicity of different widths. Note that cards embodying the invention, may also include: a) a magnetic stripe 110 for magnetically storing data; and/or b) an integrated circuit (IC) 112 for electronically storing data; and/or c) a bar code 113 annotated to store desired security information. As described below and as shown in FIG. 6, after the different layers are formed on the substrate, the card is passed through apparatus (see for example encrypter of FIG. 6) for sensing the security information on the card and encrypting the information and storing corresponding security information on the card or in a data base off the card. The apparatus (e.g., encrypter of FIG. 6) includes means for illuminating the card and means for sensing the security information on the card (e.g., the information present along a scan line 101). The encrypter may also be programmed to detect windows (W1-W9) and the location and different widths of the printed stripes within each window. The encrypter will then cause the corresponding information to be stored either on the card (e.g., on a magnetic stripe 110 or in an IC 112 or in a bar code 113) or off the card in a data base.

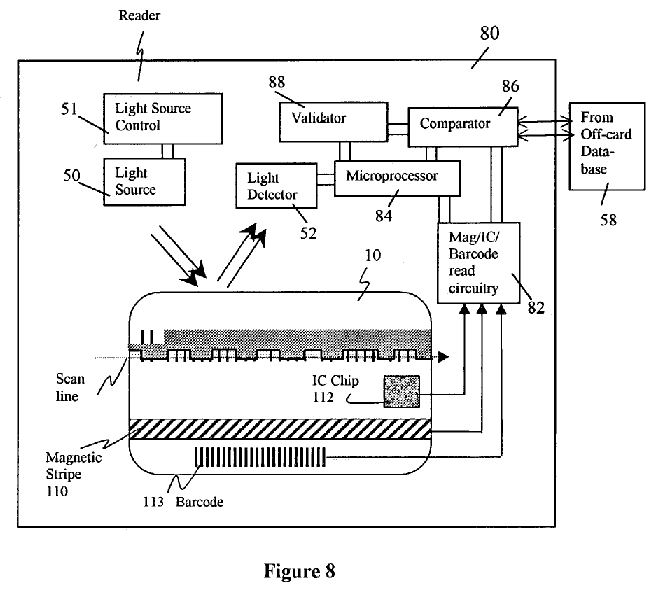

Referring to FIG. 3, there is shown a metallized pattern layer 20 with windows W1-Wn lying on the substrate 10 of the card. Another layer (which could be above or below the metallized film layer) includes a random arrangement of reflective threads or fibers (f1-fn). The threads and/or fibers may be randomly pressed into the plastic substrate of the card (as in FIG. 1E) or be placed above the surface of the substrate forming a unique pattern that is virtually impossible to duplicate. Where the pattern is formed, for example, by randomly placing (e.g., randomly throwing) fibers onto the cards, it is virtually impossible even for the manufacturer to duplicate the random placement of the threads or fibers on the card. Since there is no precise placement of the reflecting threads, it is virtually impossible to duplicate the location of the fibers. The combination of the underlying optic fiber pattern which is randomly formed and a “windowed” pattern (whether inked or metallized) makes the combination virtually impossible to duplicate. Note that it is possible for an encrypter (see FIG. 6) or a reader (see FIG. 8) to be programmed to read the information present along a first scan line 101 and/or along a second scan line 101a. Determining and programming which scan line is to be used and/or whether both should be used provides an additional degree of security to the security information on the card.

FIG. 4 shows an embodiment of the invention in which a pattern 20a is placed on a portion of the substrate 10 of a card and a multiplicity of windows (e.g., W1-W7) of different size and shape are cut-out from the pattern 20a. The pattern 20a may be similar (in size) to labels used on credit cards and the method of attaching the pattern 20a may be similar to methods presently used on credit cards. As in the case of FIG. 3, optical threads may be randomly placed on the substrate overlying (or underlying) pattern 20a and the resultant pattern is sensed by looking at the threads/fibers present in selected windows (e.g., W1-W7) along a selected scan line (e.g., scan line A). The thread or fiber information can be scanned either by means of a linear scanner (along scan line A) or it can be scanned with a two dimensional area array for sensing the entire area of pattern 20a. As above, the windows (e.g., W1-W7) in combination with the unique thread/fiber combination yields a security patter (i.e., a “fingerprint”) of the card which is virtually impossible to duplicate.

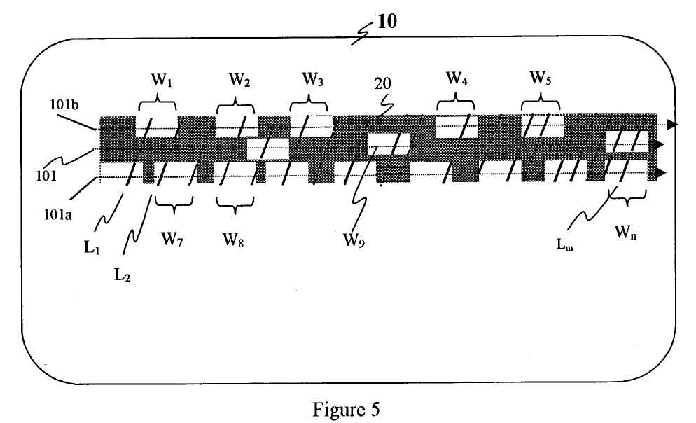

FIG. 5 shows another card embodying the invention in which: (a) a pattern of angled stripes is formed on the substrate 10 of a card; (b) a film strip 20 is placed over the stripes; and (c) a multiplicity of windows (e.g., W1-Wn) are formed throughout a metallic film strip 20 with ink stripes formed pseudo-randomly along the film strip. The card can be read along multiple scan lines (e.g., 101, 101a, 101b) to obtain multiple (different) security patterns. During a processing step for encrypting (i.e., sensing and recording) the security information present on the card, the card will typically be placed in an encrypter (see for example FIG. 6). A light source is projected on the card and the security information present along selected scan lines (e.g., 101, 101a, 101b) can be read by means of a photo detector, a linear array or an area array of photosensors. Preprogrammed “security” software within the encrypter can detect each of the multiple (e.g., three) scan lines and then the software can choose to read and process any or all of the pseudo random “security” information present on the card. This increases the security of the card since the scan line or lines of interest will be difficult if not impossible to be determined by a counterfeiter or falsifier of the card. FIG. 5, like FIG. 4, can be sensed by a photodetector or by a linear array of photosensors or by a two-dimensional photosensor of any suitable type (e.g., CCD or conventional semiconductor type).

The examples listed above refer and show that security patterns for a card embodying the invention may be formed by: a) a metallized film strip with windows (i.e., demetallized portion of the film strip); and/or b) multiple layers of different inks or ribbon transfers having different spectral responses (i.e., a first pattern and a windowed pattern).

One aspect of the invention will now be explained with reference to FIG. 1G which depicts sets of signals obtained when reading a card having the security features of the type shown in FIG. 1 and reproduced in FIG. 1G. The information generated by the metallized film pattern of FIG. 1 may be sensed by illuminating the card with a light source (e.g, 50 in FIGS. 1B, 1C, 6 and 8) and by means of one or more sensors to produce waveforms responsive to the security patterns as shown in waveforms A, B and C of FIG. 1G. Waveform A is produced by recognizing the (rising and falling) edges of the windows (cut-outs) of the metallized film 20 along a scan line 101. Note for example, that a reader (see FIG. 8) may be programmed such that the total number of windows on the card and the length of each window as well as the spacing between the various windows can be determined. Any or all of these features can be used to set up a security criteria. Waveform B is produced in response to the sensing of the stripes (L1-Lm) in each window along scan line 101. Note for example that the total number of stripes on the card as well as their relative spacing can be used to set up another security criteria. Where the stripes are formed of different widths, this information may also be used to set up another security criteria. Waveform C results from the combination of waveforms A and B. Note, for example, that the distances (e.g., x1, x2) of the stripes (e.g., L9, L10) from the edges (e.g., e3, e4) of their respective windows can be determined. This information my be used to determine or set up another set of security information criteria. Alternatively, and/or in addition, the number of stripes within each window can be determined to set up still other criteria. Evidently, a large number of different security criteria may be established and some or all may be used to determine the validity of the card.

Referring to FIG. 1G, note that the front edge (e.g., e1, e3, em−1) of a window may be used to define the start of a window pattern to be read and the back edge (e.g., e2, e4, em) of the window may be used to define the end of the window pattern to be read. The ink pattern (stripes) formed within each window may be used to define a security criterion, or the optic fibers or any type of fibers may be formed or placed within a window, as discussed above.

The waveforms (e.g., A, B or C) taken alone or in combination can be used to set up several different security criteria. Selected security information derived from the card can then be written back onto any suitable data storage element located on the card or in a data base located off the card. Subsequently, when the card is read by a reader, the reader can read the information on the card and compare the sensed information versus the previously stored security information, present on or off the card, to determine whether the card is valid.

B—Reading and Recording the Secuirty Code on the Card—

FIG. 6 shows a simplified block diagram of a reader/encrypter 60 which includes a light source 50 for illuminating cards encoded with a security pattern of the type shown in the various figures. The encrypter 60 also includes a light detector 52, which may comprise one or more light sensors, to sense the light reflected from the security pattern as shown in FIG. 1B or which passes through the card as shown in FIG. 1C. The light sensors 52 (which may include a photodetector or linear arrays or two-dimensional arrays of photosensors) sense the ink patterns (stripes) within the windows (or whatever pattern results from the combination of two, or more, layers formed or placed on a card) and produce corresponding signals which are then fed to a microprocessor 54 for processing. The microprocessor 54 may be programmed to establish various circuitry criteria and to produce “security” signals corresponding to the sensed information. The security signal can then be written back on the card via a write back circuit 56. The write back circuit produces signals to encode a magnetic stripe 110 and/or an IC 112 formed or located on the card. In addition, it should be noted that the microprocessor 54 and write back circuit may be programmed to generate a bar code and to print a bar code 113 on the card as shown in FIGS. 2, 6, and 8. The write back circuit 56 can also be designed and programmed to send security information obtained from sensing the various patterns on the card to an off-card data base 58. After the security elements (e.g., the first and second layers) are formed and positioned on the card, the resultant pattern formed on the card needs to be sensed. The pattern may be sensed in at least the following ways:

(a) with the card stationary within a reader/encrypter or even with the card moving:

(i)—by projecting a beam of light along a scan line (e.g., 101 in FIG. 1) across the length (or width) of the card so as to intersect edges of the windows and the ink lines; and

(ii) sensing the light reflected from (or passed through) the card by means of a photodetector or photosensors; and

(iii) sending the signals from the photodetector or photosensors to a microprocessor for processing the signals.

(b) like in a slot reader—projecting a light beam on a fixed point, or along a scan line, onto a moving card (i.e., defining the scan line) and then sensing either the reflected light (i.e., the sensor would be on the same side of the card as the light source) or the light passing through the card (i.e., the sensor would be on the opposite side of the card as the light source).

(c) Projecting a line of light across the entire length of the card (thereby defining a scan line) and sensing the reflected (or transmitted) light in parallel using a linear array of photodetectors or photosensors (e.g., a linear CCD array).

Note that in (a), (b) or (c) above the line of light or the beam of light may be moved up or down along the width (or length) of the card to generate a plurality of parallel scan lines.

(d) projecting light onto the entire card and using an area array of photsenosrs to sense the total light reflected and/or transmitted in the illuminated portion of the card.

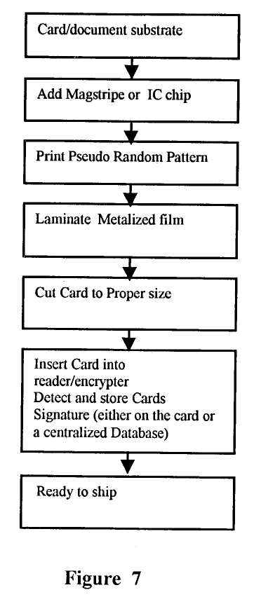

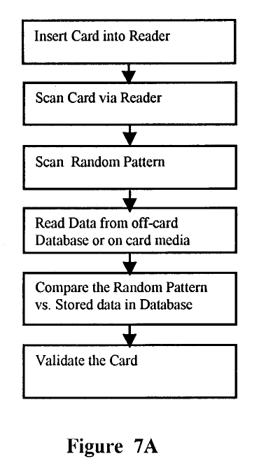

Steps in the manufacture of a card embodying the invention are shown in FIG. 7. A magnetic stripe (e.g., 110) and/or an IC (e.g., 120) may be attached to the card. Then, a first patterned layer (e.g., a pseudo-random pattern) is formed on the substrate. Then a second layer, which may be a laminated metalized film, is formed over the first layer. As noted above, the second layer may be formed between the opt and bottom surfaces or above the top surface. Then the card is cut to a desired size. In accordance with one aspect of the invention the card is then inserted into an encrypter (e.g. as shown, for example, in FIG. 6) which detects the card's various security features, which may also be referred to as the “footprint” or “signature”, and then stores corresponding information on the card or in a data base off-card (e.g., in a centralized data base). The card with its security pattern is then ready to be sent to an ultimate user for subsequent use.

In systems embodying the invention, the cards, as manufactured, contain a “security” pattern which may be read/sensed optically. Also, information corresponding to the optical “security” pattern is stored electronically or magnetically on the card or off the card. In accordance with the invention, FIG. 8 shows that to read a card embodying the invention, a reader 80 (like encrypter 60 of FIG. 6) includes a light source 50 and light source control 51 for projecting a scan line or multiple scan lines along the length (width) of the card. Light source 50 and light control 51 may include means for producing multiple scan lines and or for illuminating an entire card or a selected part of a card simultaneously. Thus, the reader system 80 includes means for projecting scan lines across the ink stripes and windows to read the security pattern on the card and means to process the corresponding sensed data to determine the optical fingerprint or characteristic of the card. The reader 80 (like encrypter 60) may include a plurality of photosensing means (generically included in light detector 52) to read the security pattern on the card. A laser reader is not needed to sense the patterns generated in accordance with the invention. Therefore this allows for the manufacture of an inexpensive reader.

Thus when a card is subsequently read (after being encrypted or after the fingerprint is recorded in an off-card data base) it may be read by a “card reader” (e.g., 80 in FIG. 8) which can sense the same information as the encrypter or detector shown in FIG. 6. In addition the “card reader” must compare the sensed fingerprint to the stored data (located on card or off-card) to ensure the card is not counterfeit. Steps in reading a card or instrument after it has been encrypted are shown in FIG. 7A. the card is inserted into a reader which scans the security patterns formed on or within the card. After the security patterns are read and the information is processed, the processed information is compared to previously stored data located on the card or off the card. If the comparison indicates that there is a match the card or instrument is validated.

Therefore the reader 80 also includes means 82 to either read: (a) the magnetic information stored in the magnetic stripe 110; and/or (b) the information stored in an IC 112; and/or the bar code information 113 written onto the card/instrument. The reader 80 also includes means for receiving previously stored security information pertaining to the card from an off-card data base 58 in which security information was previously loaded. The optical security data sensed by the reader is fed to a microprocessor 84 which then causes the sensed optical signals to be compared in a comparator 86 (which may be part of the processor 84) to the previously stored on card or off-card signals. A validator 88 compares the sensed signals to the previously stored signals to determine the validity of the card.

It has thus been shown that cards embodying the invention include unique security features resulting from the use of two different patterns and that information corresponding to the security features may be stored on or off the cards. In subsequent use of these cards a reader reads the security features and compares information sensed from the security features versus previously stored information in order to validate the card.

What is claimed is:

1. A card with increased security features comprising:
a substrate;
first and second layers formed over the substrate; said first layer containing a first pattern and said second layer containing a second pattern; and
wherein said first and second patterns are formed randomly relative to each other.

2. The card as claimed in claim 1, further including a data storage element located on the card and means for sensing the resulting pattern formed by the first and second patterns and storing signals corresponding to the resulting pattern in the storage element.

3. The card as claimed in claim 1, further including means for sensing the resulting pattern formed by the first and second patterns and storing signals corresponding thereto in a data base external to the card.

4. The card as claimed in claim 1 wherein the second pattern is formed to have windows and wherein the portion of the first pattern observed in selected ones of these windows defines a security feature of the card.

5. The card as claimed in claim 1 wherein said second pattern includes a metal strip formed along the card, and wherein said second pattern includes cut outs within the metal strip.

6. The card as claimed in claim 5 wherein said cut outs within the metal strip are of different size and shape relative to each other and are randomly formed along the metal strip.

7. The card as claimed in claim 1 wherein one of said first and second patterns is formed using ink patterns and wherein the other one of said first and second patterns is formed using a metallic film.

8. The card as claimed in claim 1 wherein one of said first and second patterns is formed using one type of ink and wherein the other one of said first and second patterns is formed using another type of ink.

9. The card as claimed in claim 4, wherein said first pattern includes randomly placed fibers.

10. The card as claimed in claim 4, wherein said first pattern includes randomly spaced fibers, formed parallel to each other along one of the length and width of the card.

11. The card as claimed in claim 4, wherein said first pattern includes marks of different geometric shape.

12. The card as claimed in claim 1 wherein said first pattern is formed of material which is non-visible to the human eye, and wherein the second pattern includes a metallized strip overlying the first pattern.

13. The card as claimed in claim 1 wherein said first pattern is formed of a material which is non-visible to the human eye and includes ink lines responsive to one of UV and IR radiation.

14. The card as claimed in claim 5 wherein the resulting pattern is determined by sensing the pattern existing along a scan line running along the length of the metal strip across the cut outs.

15. The card as claimed in claim 5 wherein the resulting pattern is determined by sensing the pattern existing along a plurality of scan lines running along the length of the metal strip across selected cut outs.

16. The card as claimed in claim 5 wherein portions of the metallized strip forming the second patterned layer are cut out to create windows to the underlying first pattern and wherein a resulting security pattern includes a combination of those portions of the first pattern present within the windows of the second pattern.

17. The card as claimed in claim 1 wherein one of said first and second patterns is comprised of optical marks having different geometric shapes.

18. The card as claimed in claim 1 wherein at least one of said first and second patterns is formed in a random manner.

19. A method for increasing the security of an instrument having a substrate comprising the steps of:
forming a first pattern along a first layer on said substrate;
forming a second pattern along a second layer overlying said first layer; said second pattern being random relative to the first pattern; and
sensing the resultant pattern produced by the first and second patterns and storing signals corresponding to the sensed resultant pattern.

20. The method as claimed in claim 19, wherein the step of storing signals includes storing the signals on a storage element located on the substrate of the instrument.

21. The method as claimed in claim 19, wherein the step of storing signals includes storing the signals in a data base located externally to the instrument.

22. The method as claimed in claim 19 wherein at least one of the patterns is formed in a random manner.

23. The method as claimed in claim 19 wherein the step of forming the second pattern includes forming windows in the second layer to enable the first layer to be observed whereby there is formed: (a) a first pattern in the first layer; (b) a second pattern in the second layer; and (c) a third pattern comprising the combination of the first and second patterns which includes the portion of the first pattern seen in the windows of the second pattern.

24. Apparatus for use with an instrument having first and second patterned layers formed on a substrate and with data storage means located on the instrument comprising:
a light source for illuminating the instrument;
photosensing means for sensing signals produced by the first and second patterns in response to the illumination;
processing means responsive to the photosensing means for producing data signals corresponding to the sensed signals; and
means for storing said data signals in at least one of: (a) said data storage means located on the instrument; and (b) a data base external to the instrument.

25. Apparatus for use with an instrument having first and second patterned layers formed on a substrate and with data storage means located on the instrument comprising:
a light source for illuminating the instrument;
photosensing means for sensing signals produced by the first and second patterns in response to the illumination;
processing means responsive to the photosensing means for producing data signals corresponding to the sensed signals;
means for sensing previously stored data signals in at least one of: (a) said data storage means located on the instrument; and (b) a data base external to the instrument; and
means for comparing the previously stored data with the data signals to ascertain the validity of the instrument.

26. A system for impeding the counterfeiting of an instrument comprising:
forming first and second layers on the instrument, with each layer having a different pattern and wherein the pattern formed in the second layer includes windows formed in the second layer to observe the pattern of the first layer;
encrypting apparatus for sensing the first and second patterns and including means for storing data signals corresponding to said first and second patterns in at least one of: (a) data storage means located on the instrument; and (b) a data base external to the instrument; and
reader apparatus for sensing the instrument, after encryption, including means for sensing the first and second patterns and including means for sensing previously stored data signals in at least one of: (a) said data storage means located on the instrument; and (b) said data base external to the instrument; and
means for comparing the previously stored data with the data signals to ascertain the validity of the instrument.

27. An instrument comprising:
a top surface; a bottom surface; and at least one intermediate layer between the top and bottom surfaces;
a first security pattern formed within said at least one intermediate layer, and
a second pattern formed either on one of said top and bottom surfaces or within said at least one intermediate layer, said second pattern being formed independently of said first pattern and randomly relative to said first pattern, whereby the combination of the first and second patterns provides a unique resultant pattern.

28. An instrument as claimed in claim 27 wherein the second pattern is formed between the top and bottom surfaces.

29. An instrument as claimed in claim 27 wherein the second pattern is formed on the top surface.

30. An instrument as claimed in claim 27 wherein said first and second patterns are detectable by apparatus designed to sense their presence for producing data signals corresponding to the resultant pattern.

31. An instrument as claimed in claim 27 wherein said apparatus includes means for processing the data signals and encoding data corresponding to the data signals onto the instrument.
